(19) United States
(12) Patent Application Publication
(10) Pub. No.: US 2026/0084217 A1
(43) Pub. Date: Mar. 26, 2026

(54) LASER POWDER BED FUSION METHODS AND APPARATUS

(71) Applicant: RENISHAW PLC, Wotton-under-Edge , Gloucestershire (GB)

(72) Inventors: John DARDIS, Wotton-under-Edge (GB); Robert James BROWN, Wotton-under-Edge (GB); Jonathan MANSELL, Wotton-under-Edge (GB)

(73) Assignee: RENISHAW PLC, Wotton-under-Edge , Gloucestershire (GB)

(21) Appl. No.: 19/103,445

(22) PCT Filed: Aug. 17, 2023
(86) PCT No.: PCT/GB2023/052164

§ 371 Date: Feb. 12, 2025

(30) Foreign Application Priority Data
Aug. 22, 2022 (GB) 2212186.7

(51) Int. Cl. B22F 12/49; B22F 10/28; B33Y 10/00; B33Y 30/00

(52) U.S. Cl. CPC B22F 12/49; B22F 10/28; B33Y 10/00; B33Y 30/00

(57) ABSTRACT

A method includes a plurality of scanners, each scanner directing a corresponding laser beam to different positions on a powder bed, an isotropic position sensitive detector arranged to detect electromagnetic radiation arising from interaction of the laser beams with the powder bed and a movable optical component for moving a field of view of the isotropic position sensitive detector to different positions on the powder bed. The method includes positioning the movable optical component and/or a first or second scanner of the plurality of scanners such that a first or second point irradiated by a first or second laser beam of the first or second scanner within the field of view of the isotropic position sensitive detector and recording a first or second position of an image on the isotropic position sensitive detector generated during irradiation of the first or second point by the first or second laser beam.

### FIELD OF INVENTION

This invention concerns laser powder bed fusion methods and apparatus. The invention has particular application to methods and apparatus for aligning scanners in a powder bed fusion apparatus.

### BACKGROUND

In laser powder bed fusion, a powder layer is deposited on a powder bed in a build chamber and a laser beam is scanned across portions of the powder layer that correspond to a cross-section (slice) of the workpiece being constructed. The laser beam melts or sinters the powder to form a solidified layer. After selective solidification of a layer, the powder bed is lowered by a thickness of the newly solidified layer and a further layer of powder is spread over the surface and solidified, as required.

WO2014/199134 A1 discloses a powder bed fusion apparatus comprising a plurality of optical modules, each optical module for directing a corresponding laser beam to the powder bed. The optical modules are arranged such that a scanning zone across which each laser beam can be directed overlaps or is coterminous with a scanning zone of at least one other laser beam.

To form a workpiece accurately the optical modules have to be calibrated such that the coordinate systems of the optical modules are aligned. Such a calibration may have to be carried out multiple times during a build as the location of the optical modules relative to each other and the powder bed may shift due to heating of the powder bed fusion apparatus and consequential expansion and/or contraction of parts of the apparatus.

WO2017/187147 A1 discloses a method for calibrating optical modules of an additive manufacturing apparatus, wherein a calibrated one of the optical modules directs its corresponding laser beam to a defined x, y position on a working plane to form a melt pool. At least one, and possibly all, of the uncalibrated optical modules is/are directed to the same position such that the melt pool is within the field of view of an on-axis detector of the uncalibrated module(s). An image of the melt pool is captured on the on-axis detector of the or each uncalibrated optical module. A controller determines a location of the centre of the melt pool and determines a correction value to correct for misalignment of the calibrated and uncalibrated optical modules.

US2018/0093416 A1 discloses a method of determining a relative calibration of at least two scanners relative to one another. A first one of the scanners is directed towards a target point in an overlap area and an on-axis sensor has a first monitoring region with a centre coinciding with the target point. A second scanner guides a laser beam over the powder in a stripe-shaped path such that it passes several times through the monitoring region. A relative position of the target point to the path can be determined from a recorded intensity and a correction value determined.

EP3527352 A1 discloses a method of calibrating an irradiation system wherein a control unit is adapted to determine a position of at least one intersection point between an irradiation pattern produced by a first irradiation unit and a second operating axis of a second irradiation unit. The position is determined based on signals generated by a second detector, aligned with the second operating axis of the second irradiation unit.

These processes assume that a location of a laser beam directed by a scanner in the field of view of its on-axis detector is known. Calibration methods can be used to align a field of view of the on-axis detector and with the laser beam, such as described in WO2020/174240 A1. However, subsequent relative movement between the optical module and the on-axis detector, for example due to heating of the modules during the build, can change this alignment. Accordingly, it is desirable to provide a method of determining misalignment of the coordinate systems of scanners in a powder bed fusion apparatus that does not rely on knowledge of a position of a laser beam directed by a scanner within a field of view of an on-axis detector that views the powder bed through the optical axis of that scanner.

US2022/080668 discloses generating a first calibration pattern and a second calibration pattern, in the simplest case spots of the energy beams. The first calibration pattern and the second calibration pattern are imaged by a first on-axis determination unit of a first irradiation unit that generates the first pattern. From the image, a relative position is determined and the irradiation units can be suitably adjusted.

Using an on-axis sensor to detect a spot of the laser beam that is directed by the corresponding scanner can be problematic because of internal back-reflections of the laser beam from optical components of the scanner that can result in multiple images of a single laser beam spot on the on-axis sensor.

US2018/0207750 A1 discloses systems and method for in-build assessment and correction of laser pointing accuracy for multi-laser systems in additive manufacturing. The system comprises an optical system configured to detect electromagnetic radiation generated by the melt pool, wherein a scanning device, operated independently from the laser scanners, directs electromagnetic radiation generated by the melt pool to an optical detector. The optical detector detects a position of melt pools. When detecting the position of melt pools, observation zone moves with the same velocity as melt pools and the position of the melt pools is in the centre of the observation zone.

When moving a laser beam across the powder bed, a portion of a melt pool 113 formed by melting of the powder by the laser beam lags behind the laser beam spot 119, as illustrated schematically in FIGS. 9 and 10. Accordingly, a centre of the melt pool 113 does not correspond to a position of the laser beam 118. Furthermore, a shape and size of the melt pool 113 is dependent on the laser parameters used and may be difficult to determine as the melt pool will be at least partially obscured from an on-axis sensor by a plasma plume 114 formed above the melt pool. Yet further, the formation of a melt pool changes the state of the material such that either the calibration scans become part of the object being built or separate dedicated calibration objects must be built. Finally, refraction along the optical axis is likely to be wavelength dependent, such that temperature changes in in melt pool, which cause changes in the wavelengths of electromagnetic radiation generated by the melt pool, may cause changes in a spatial position of an image of the melt pool on a detector. This is particularly the case if the detector is located behind a window which separates process emissions, such as vaporised material and particles ejected from the melt pool, from reaching the detector.

US2022/0193785 A1 discloses a device for calibrating an irradiation system of an apparatus for producing a three-dimensional workpiece. An optical detection unit comprises an optical detector and an objective lens for optically detecting a portion of the irradiation plane, and is configured to detect the position of the spot of the irradiation beam in multiple focal planes based on a focal length of the optical detection unit being adjustable.

### SUMMARY OF INVENTION

According to a first aspect of the invention there is provided a method of aligning positioning of a laser beam in a laser powder bed fusion apparatus, the laser powder bed fusion apparatus comprising a scanner for directing the laser beam on to a powder bed.

The method may be for aligning the positioning of laser beams in a laser powder bed fusion apparatus comprising a plurality of scanners, each scanner for directing a corresponding laser beam to different positions on a powder bed.

The laser powder bed fusion apparatus may comprise a position sensitive detector arranged to detect electromagnetic radiation arising from interaction of the laser beams with the powder bed. The laser powder bed fusion apparatus may comprise a movable optical component, such a movable optical component of a scanner, for moving a field of view of the position sensitive detector to different positions on the powder bed.

Preferably, the position sensitive detector (of any that is described herein) is an isotropic position sensitive detector. Isotropic position sensitive detectors do not require a device for adjusting a focus of the image on the position sensitive detector based on a position of the laser beam on the powder bed because isotropic position sensitive detectors can operate out of focus. An isotropic position sensitive detector determines a centroid of the image, such as that of a laser spot or melt pool. If an image is out of focus (thus creating a larger image on the isotropic position sensitive detector) the same centroid position should still be determined. An image may be out of focus because optics on the optical train between the powder bed and isotropic position sensitive detector may be tailored for the laser wavelength rather than wavelengths of electromagnetic radiation arising from interaction of the laser beams with the powder bed. An isotropic position sensitive detector can generate position data much faster and is typically cheaper than a camera.

Additionally or alternatively, in the case where the isotropic position sensitive detector is located to detect electromagnetic radiation arising from interaction of the laser beams with the powder bed that travels back along an optical path for steering a laser beam and is picked off from the optical path, the electromagnetic radiation may be picked-off (split from the laser beam path) before the electromagnetic radiation has passed back through movable focussing optics for dynamically focussing the laser beam as the laser beam is steered over the powder bed to maintain a focus of the laser beam in a desired plane (flatten the scan field of the laser beam). As the electromagnetic radiation is picked-off before passing through the movable focussing optics, the electromagnetic radiation may be out of focus on the isotropic position sensitive detector. Such an arrangement may be desirable as the pick-off mirror can be used as a turning mirror between the movable focussing optics and steering optics of a scanner. In this way, the focussing optics can be located above the steering optics, allowing reductions in a horizontal footprint of the scanner and/or a height of the scanner between the steering optics and an output opening through which the laser beam exits the scanner. This may enable closer packing of a plurality of scanners.

Furthermore, the isotropic position sensitive detector is out of the way of other optics that may be located before the focussing optics in the laser beam optical beam path, such as a piezo-actuated steering mirror, as disclosed in WO2016/156824, which is incorporated herein in its entirety by reference. A field of view of the isotropic position sensitive detector is typically larger than an optical aperture of a piezo-actuated steering mirror. Accordingly, it is desirable to locate the isotropic position sensitive detector after the piezo-actuated steering mirror (“after” from the point of view of travel of the laser beam along the optical path) such that the field of view of the isotropic position sensitive detector is not limited by a size of an optical aperture of the piezo-actuated steering mirror. Furthermore, it is desirable to locate the piezo-actuated steering mirror close to the beam delivery optic (BDO) of the laser beam. Reducing a number of turning mirrors in the laser beam path reduces losses in the system, reducing undesirable heating of a scanner.

However, in a less preferred embodiment, the position sensitive detector is a discrete sensor, such as a CCD or CMOS camera.

The method may comprise positioning the movable optical component and/or a first scanner of the plurality of scanners such that a first point irradiated by a first laser beam of the first scanner is within the field of view of the position sensitive detector and recording a first position of an image on the position sensitive detector generated during irradiation of the first point by the first laser beam. The method may comprise positioning the movable optical component and/or a second scanner of the plurality of scanners such that a second point irradiated by a second laser beam of the second scanner is within the field of view of the position sensitive detector and recording a second position of an image on the position sensitive detector generated during irradiation of the second point by the second laser beam. The method may comprise determining an adjustment to be made to positioning of at least one of the plurality of scanners based on the first and second positions compared to an expected positioning. The adjustment may be based on a position vector, in the reference frame of the position sensitive detector or the field of view, derived from the first and second positions.

In this way, an alignment of a field of view of the position sensitive detector relative to an optical axis of the movable optical component does not need to be determined as the relative positioning of the first and second positions is used to determine the adjustment rather than a position in a reference frame determined from a positioning of the movable optical component. The field of view may be offset from a nominal position when recording the first and second positions (for example, because of misalignment between the position sensitive detector and an optical axis of the movable optical component), but this offset from the nominal position is the same for both the first and second positions. Accordingly, any offset will be removed when determining the relative positioning. Thermal effects may cause relative changes in positioning of the field of view relative to an optical axis of the movable optical component. Accordingly, relying on an assumed position of the field of view as given by a position of the movable optical component can lead to inaccuracies in calibration.

As recording of the first and second positions is carried out during irradiation of points by the first and second laser beams, a separate time does not need to be allocated for the position sensitive detector to capture these positions. This may allow the recording of the positions to be integrated with irradiation of a powder bed with the first and second laser beams for other purposes, such as for melting, preheating, controlling the cooling of material and/or the gettering of oxygen before the build commences (wherein the build substrate is heated by the laser beams to cause it to absorb oxygen within atmosphere in a build chamber).

The adjustment may be determined by transforming the first and second positions or the relative positioning to corresponding positions or a corresponding relative positioning in a field of view of the position sensitive detector on a surface of the powder bed. The transformation may be a scaling to take into account a magnification of optical components between the position sensitive detector and the surface of the powder bed. A position in the field of view means a location within the frame of reference of the field of view, i.e. a position defined in a coordinate system whose origin, orientation and scale are given by the field of view of the position sensitive detector on a surface of the powder bed and whose relationship to a plane of the powder bed or a coordinate system of the movable optical component and plurality of scanners may be unknown or require a transformation (typically through a calibration). The method may avoid the need to transform the first position and second position in the field of view to a position in another coordinate system, such as the plane of the powder bed or a coordinate system of the movable optical component and plurality of scanners.

The expected positioning may be determined from a difference in locations of the first and second points in the reference frame of the field of view. A difference in locations of the first and second points in the reference frame of the field of view could be due to a difference in a position of the field of view between recording the first and second positions and/or a difference in (nominal) locations of the first and second points on the powder bed. The vector sum of these two differences gives the expected positioning. The expected positioning may be zero if there is no change in the position of the field of view between recording the first and second positions and the (nominal) location of the first and second points is the same or if any change in the position of the field of view between recording the first and second positions is the same (both in magnitude and direction) as the difference in the (nominal) locations of the first and second points.

A “nominal location” is a demand position on a surface of the powder bed the system sends to the corresponding scanner. The actual point of irradiation may differ from the nominal location due to drift in positioning of the laser beam by the scanner from a calibrated position, for example due to temperature differences between calibration and a time of the irradiation.

The method may comprise positioning the movable optical component and/or a first scanner of the plurality of scanners such that a plurality of first points irradiated by the first laser beam of the first scanner is within the field of view of the position sensitive detector and recording a plurality of first positions, each first position corresponding to an image on the position sensitive detector generated during irradiation of a different one of the first points by the first laser beam. The method may comprise positioning the movable optical component and/or a second scanner of the plurality of scanners such that a plurality of second points irradiated by the second laser beam of the second scanner is within the field of view of the position sensitive detector and recording a plurality of second positions, each second position corresponding to an image on the position sensitive detector generated during irradiation of a different one of the second points by the second laser beam.

The expected positioning may be determined from a difference in locations of a first feature derived from the plurality of first points and a second feature derived from the plurality of second points. For example, the method may comprise determining a first centroid of the plurality of first positions and a second centroid of the plurality of second positions and the adjustment is determined from comparing a position vector between the first and second centroids to an expected positioning of the first and second centroids. The first plurality of points and the second plurality points may be located in nominally the same pattern. The pattern may be a geometrical shape, such as a regular polygon or ellipse, and preferably a circle. The first and second centroids may be located at nominally the same position in the field of view. The alignment may be determined from a non-zero offset between the first and second centroids in the field of view. The first and second centroids may be nominally located at different points on the powder bed as the movable component may move the field of view between recording the plurality of first positions and the plurality of second positions. The field of view of the position sensitive detector may be stationary on a surface of the powder bed when recording the plurality of first positions and the plurality of second positions (but may be moved between recording each plurality). The method may comprise nominally positioning the field of view in the same relationship relative to the plurality of first positions and the plurality of second positions. For example, an optical axis that passes through the movable optical component may be nominally located at the centroid. However, due to drift in the steering of the optical axis, drift in the steering of the corresponding laser beam by the first and/or second scanner, and/or misalignment between the position sensitive detector and the optical axis, a centre of the field of view may not be located at the centroid.

The recording of first positions and second positions may be alternated. For example, the first and second laser beams may be repeatedly modulated between a high power that results in electromagnetic radiation detectable by the position sensitive detector and a low power that does not result in electromagnetic radiation detectable by the position sensitive detector, wherein a timing of the repeated modulations is such that the first laser beam is at the high power when the second laser beam is at the low power and the second laser beam is a the high power when the first laser beam is at the low power. The low power may be the laser beam being turned off.

The method may comprise recording the first and second positions when the first and second lasers are melting powder. The method may comprise recording the first position when the first laser beam is irradiating, such as melting, the material and the second laser beam is not irradiating, such as melting, the material and recording the second position when the second laser beam is irradiating, such as melting, the material and the first laser beam is not irradiating, such as melting, the material. In this way, which laser beam that resulted in the detected position can be easily determined from the time of capture. If the laser beams irradiate the same nominal point, or points close together, on the material at the same time, it may be difficult to determine which laser beam generated which position and this may also cause inaccuracies in the determination of the first and second positions using the position sensitive detector. Potentially, one of the laser beams could irradiate material outside of the field of view whilst the other laser beam irradiates a point in the field of view. However, there may be an unacceptable delay associated with repositioning the laser beam or the field of view such that the second position can be recorded.

The movable optical component may steer neither of the first laser beam and the second laser beam. In this way, inaccuracies in the determination of the first and second positions is not caused by back-reflections of the first and second laser beams from optical components within the optical path of the first and second scanners. The movable optical component may be an optical component for steering a third laser beam directed by a third scanner of the plurality of scanners (different to the first and second scanners) (hence the position sensitive detector may be referred to herein as a third scanner position sensitive detector). The position sensitive detector may be an on-axis detector of the third scanner. Accordingly, movable optical components in addition to those used for steering the laser beams can be avoided. The third laser beam may be turned off when recording the first and second positions.

The position sensitive detector may be arranged to detect electromagnetic radiation of the wavelength of the first and second laser beams. Accordingly, the method may comprise recording a first position of an image on the position sensitive detector formed by laser light reflected from the powder bed. The first and second laser beams may have the same wavelength. In this way, the position sensitive detector records a position of a spot of the first and second laser beams rather than a position of the resultant melt pool or plasma plume. The laser beam spot is insensitive to scan parameters such as scan speed, scan direction and power. The method may comprise irradiating the first and second points with the first and second laser beam having a fluence below that required to melt the powder. In this way, the method of aligning the positioning of the laser beams can be carried out without consolidating material. Furthermore, when the position sensitive detector is an on-axis detector of the other one of the scanners, the detected electromagnetic radiation is less likely to be adversely refracted by the optical components in between the laser spot and the positions sensitive detector because the optical components will have been arranged to accurately direct electromagnetic radiation having this wavelength. Furthermore, the reflections of the laser light have a much higher intensity compared to emissions from the plasma plume or melt pool. In addition, reflected laser light is unlikely to contain useful information about melt pool formation, whereas electromagnetic radiation emitted from the plasma plume and/or melt pool may contain a signature indicative of whether the required melting conditions have been achieved. Accordingly, it may be advantageous to reserve the wavelengths of electromagnetic radiation emitted from the plasma plume and/or melt pool for pyrometry whilst using reflected laser light for metrology.

The method may comprise recording a position of a spot generated by the first and second laser beams when irradiating powder of a powder bed. The powder acts as a diffuse reflector of the laser light enabling the position sensitive detector, which is not on the optical axis of the laser beam, to detect the laser light reflected away from the optical axis of the laser beam.

Alternatively, the position sensitive detector may be arranged to detect electromagnetic radiation emitted by a plasma plume generated during irradiation of material by the first and second laser beams. Using electromagnetic radiation emitted by a plasma plume for metrology may allow for irradiation of polished metal surfaces, such as a build substrate, by the first and second laser beams to be used for determining the adjustment to the positioning of the at least one scanner. In this way, the method may be carried out before a powder layer is formed. In such an embodiment, the laser wavelength and a wavelength of the detected radiation may not be the same.

The second scanner may comprise a second scanner position sensitive detector (arranged to detect electromagnetic radiation arising from interaction of the laser beams with the powder bed and view the powder bed via a movable optical component of the second scanner used to steer the second laser beam) and the position sensitive detector may be a third scanner position sensitive detector of a third scanner of the plurality of scanners (arranged to detect electromagnetic radiation arising from interaction of the laser beams with the powder bed and view the powder bed via a movable optical component of the third scanner used to steer a third laser beam). The method may comprise positioning the second scanner and/or the third scanner such that a third point irradiated by a third laser beam of the third scanner is within the field of view of the second scanner position sensitive detector and recording a third position of an image on the position sensitive detector generated during irradiation of the third point by the third laser beam. The method may comprise positioning the first scanner and/or the second scanner such that the first point and/or a fourth point irradiated by the first laser beam of the first scanner is within the field of view of the second scanner position sensitive detector and recording a fourth position of an image on the position sensitive detector generated during irradiation of the first and/or fourth point by the first laser beam.

The method may comprise determining the adjustment to be made to positioning of at least one of the plurality of scanners based on the third and fourth positions compared to a corresponding expected positioning. The adjustment may be based on a position vector, in the reference frame of the second scanner position sensitive detector or the corresponding field of view, derived from the third and fourth positions. In this way, the adjustment is determined based on relative positioning of the corresponding laser beams by the first and second scanners (first pair) and the first and third scanners (second pair).

The first scanner may comprise a first scanner position sensitive detector (arranged to detect electromagnetic radiation arising from interaction of the laser beams with the powder bed and view the powder bed via a movable optical component of the first scanner used to steer the laser beam). The method may further comprise positioning the second scanner and/or the first scanner such that the second point or a fifth point irradiated by the second laser beam of the second scanner is within the field of view of the first scanner position sensitive detector and recording a fifth position of an image on the position sensitive detector generated during irradiation of the second or fifth point by the second laser beam. The method may further comprise positioning the third scanner and/or the first scanner such that the third point or a sixth point irradiated by the third laser beam of the third scanner is within the field of view of the first scanner position sensitive detector and recording a sixth position of an image on the position sensitive detector generated during irradiation of the third or sixth point by the third laser beam.

The method may comprise determining the adjustment to be made to positioning of at least one of the plurality of scanners based on the fifth and sixth positions compared to a corresponding expected positioning. The adjustment may be based on a position vector, in the reference frame of the first scanner position sensitive detector or the corresponding field of view, derived from the fifth and sixth positions. In this way, the adjustment is determined based on relative positioning of the first and second scanners (first pair), the first and third scanners (second pair) and second and third scanners (third pair).

The powder bed fusion apparatus may comprise a fourth scanner of the plurality of scanners. The method comprises recording with each position sensitive detector of the first, second and third scanners a further position of an image on the position sensitive detector generated during irradiation of a seventh point by the fourth laser beam of the fourth scanner. This has the advantage that at least for the fourth scanner, a relative positioning of the first laser beam and the fourth laser beam (fourth pair-determined by both the second and third scanner position sensitive detectors), second laser beam and fourth laser beam (fifth pair-determined by both the first and third scanner position sensitive detectors) and third laser beam and fourth laser beam (sixth pair-determined by both the second and third scanner position sensitive detectors) is determined multiple times using different position sensitive detectors. This information redundancy may be beneficial as it provides a way of determining a misalignment between pairs of scanners that is averaged across the different position sensitive detectors and therefore, is less prone to errors specific to any one of the position sensitive detectors.

The fourth scanner may comprise a fourth scanner position sensitive detector (arranged to detect electromagnetic radiation arising from interaction of the laser beams with the powder bed and view the powder bed via a movable optical component of the fourth scanner used to steer the fourth laser beam). The method may comprise recording with the fourth scanner position sensitive detector, for at least two and preferably each of the first, second and third points, a position of an image on the position sensitive detector generated during irradiation of the point. This has the advantage that a relative positioning of at least one pair (first, second and/or third pair) of the first, second and third laser beams is determined multiple times using different position sensitive detectors. This information redundancy may be beneficial as it provides a way of determining an alignment between pairs of scanners that is averaged across the different position sensitive detectors and therefore, is less prone to errors specific to any one of the position sensitive detectors.

The method may be for aligning the positioning of a laser beam in a laser powder bed fusion apparatus comprising a scanner for directing the laser beam on to a powder bed, the scanner comprising an optical component movable under the control of a first actuator to direct the laser beam across the powder bed in a first dimension and the or a further optical component movable under the control of a second actuator to direct the laser beam across the powder bed in the first dimension.

The method may comprise positioning the laser beam using the first actuator (with the second actuator stationary) such that a first point irradiated by the laser beam is within the field of view of the position sensitive detector and recording a first position of an image on the position sensitive detector generated during irradiation of the first point by the laser beam. The method may comprise positioning the laser beam using the second actuator (with the first actuator stationary) such that a second point irradiated by the laser beam is within the field of view of the position sensitive detector and recording a second position of an image on the position sensitive detector generated during irradiation of the second point by the laser beam.

The method may comprise determining an adjustment to be made to positioning of at the or the further optical component by the first and second actuators based on the first and second positions compared to an expected positioning. The adjustment may be based on a position vector, in the reference frame of the position sensitive detector or the field of view, derived from the first and second positions.

The second actuator may provide a faster dynamic response but a smaller range of movement of the laser beam in the first dimension than the first actuator. The first actuator may be a galvanometer. The second actuator may be a piezoelectric actuator.

The method may comprise positioning the laser beam using the first actuator (with the second actuator stationary) such that a plurality of first points irradiated by the laser beam is within the field of view of the position sensitive detector and recording a plurality of first positions, each first position corresponding to an image on the position sensitive detector generated during irradiation of a different one of the first points by the laser beam. The method may comprise positioning the laser beam using the second actuator (with the first actuator stationary) such that a plurality of second points irradiated by the second laser beam of the second scanner is within the field of view of the position sensitive detector and recording a plurality of second positions, each second position corresponding to an image on the position sensitive detector generated during irradiation of a different one of the second points by the second laser beam.

The expected positioning may be determined from a difference in locations of a first feature derived from the plurality of first points and a second feature derived from the plurality of second points. For example, the method may comprise determining a first centroid of the plurality of first positions and a second centroid of the plurality of second positions and the adjustment is determined from comparing a position vector between the first and second centroids to an expected positioning of the first and second centroids. The first plurality of points and the second plurality points may be located in nominally the same pattern. The pattern may be a geometrical shape, such as a regular polygon or ellipse, and preferably a circle. The first and second centroids may be located at nominally the same position in the field of view. The alignment may be determined from a non-zero offset between the first and second centroids in the field of view.

The powder bed fusion apparatus may comprise a movable optical component for moving the field of view of the position sensitive detector to different positions on the powder bed. The movable optical component may not steer the laser beam. The movable optical component may be an optical component for steering another laser beam directed by another scanner. The position sensitive detector may be an on-axis detector of the other scanner. Accordingly, movable optical components in addition to those used for steering the laser beams can be avoided. The other laser beam may be turned off when recording the first and second positions.

The powder bed fusion apparatus may comprise a recoater for forming a powder layer across the powder bed, the method may comprise operating the or each scanner to irradiate a point on the powder bed when the recoater is moving across the powder bed and recording a position of an image on the position sensitive detector generated during irradiation of the point/s by the laser beam/s. In this way, the recording of the positions of the laser beams may be carried out during recoating, such as wiping, of the powder.

The method may comprise determining an adjustment to be made to positioning of the scanner based on the recorded position(s) compared to an expected positioning.

The point may be located behind the recoater in the direction of travel of the recoater across the powder bed when the point is irradiated. A region behind the recoater will be newly laid powder that has yet to be consolidated. The position sensitive detector may be arranged to detect electromagnetic radiation of the wavelength of the laser beam(s). In this way, the position sensitive detector records a position of a spot of the laser beam(s) rather than a position of the resultant melt pool or plasma plume. The method may comprise generating the reflected laser light by irradiating the powder with the laser beam having a fluence below that required to melt the powder. In this way, the method of aligning the positioning of the laser beams can be carried out without consolidating material.

At the same time as recording the position on the position sensitive detector, another scanner may irradiate the powder bed to consolidate material, for example, by melting or sintering the powder. The powder may be consolidated in front of the wiper in the direction of travel of the recoater across the powder bed when the point is irradiated.

The method may comprise irradiating powder of the powder bed using a first laser beam directed by a first scanner of the plurality of scanners such that the irradiated powder remains unconsolidated (a low fluence scan) and, during the irradiation, capturing with the position sensitive detector first positions on the powder bed of first points irradiated using the first laser beam; irradiating powder of the powder bed using a second laser beam directed by a second scanner of the plurality of scanners such that the irradiated powder remains unconsolidated and, during the irradiation, capturing with the position sensitive detector second positions on the powder bed of second points irradiated using the second laser beam; comparing the first and second points with one another; determining a relative deviation between the first and second positions; and aligning the first and second scanners based upon the deviation. For example, the first and second scanners may be aligned such that the deviation between the first positions and the second positions falls below a setpoint value after alignment.

The method may be in accordance with that set out in WO2014/180971, which is incorporated in its entirety herein by reference, but rather than consolidating material, the material remains unconsolidated. The position sensitive detector may be a camera fixed in the build chamber arranged to detect the laser wavelength. The method may comprise multiple images at different times during the irradiations by the first and second laser beams or multiple first and second points may be captured through a single long exposure of the camera. Furthermore, an isotropic position sensitive detector may be used instead of a camera. It is advantageous not to consolidate powder as the alignment method does not need to be allocated a dedicated area of the powder bed and does not affect the result part build by consolidating material. Furthermore, capturing of the first and second positions may be carried out during consolidation of material by other laser beams as the position sensitive detector will not be blinded by the high intensity of the reflected laser light.

The irradiation of the powder bed by the first and second laser beams may be in the scan patterns described in WO2014/180971 or those described herein, e.g. centroids of defined shapes, such as circles.

The position sensitive detector may be mounted such that a field of view of the position sensitive detector is fixed with respect to a working surface of the powder bed, for example the fixed camera arranged to detect the laser wavelength. Alternatively, the laser powder bed fusion apparatus may comprise a movable optical component, such a movable optical component of a scanner, for moving a field of view of the position sensitive detector to different positions on the powder bed. The method may comprise each of the first positions and each of the second positions with two or more position sensitive detectors. For example, two position sensitive detectors mounted such that the field of view of each position sensitive detector is fixed with respect to a working surface of the powder bed or the position sensitive detector or each of two or more scanners.

According to a second aspect of the invention there is provided a powder bed fusion apparatus comprising a scanner for directing a laser beam to different positions on a powder bed and a position sensitive detector arranged to detect electromagnetic radiation arising from interaction of the laser beams with the powder bed.

The position sensitive detector may be an isotropic position sensitive detector.

The powder bed fusion apparatus may comprise a plurality of scanners, each scanner for directing a corresponding laser beam to different positions on a powder bed.

The powder bed fusion apparatus may comprise a movable optical component for moving a field of view of the position sensitive detector to different positions on the powder bed.

The plurality of scanners may comprise first, second and third scanners for steering first, second and third laser beams, respectively. The movable optical component may be an optical component of the third scanner for steering the third laser beam. In such an embodiment, the position sensitive detector is a third scanner position sensitive detector arranged to detect electromagnetic radiation arising from interaction of the laser beam with the powder bed and view the powder bed via the movable optical component of the third scanner used to steer the second laser beam.

The second scanner may comprise a second scanner position sensitive detector arranged to detect electromagnetic radiation arising from interaction of the laser beams with the powder bed and view the powder bed via a movable optical component of the second scanner used to steer the second laser beam.

The first scanner may comprise a first scanner position sensitive detector arranged to detect electromagnetic radiation arising from interaction of the laser beams with from the powder bed and view the powder bed via a movable optical component of the first scanner used to steer the first laser beam.

The powder bed fusion apparatus may comprise a fourth scanner of the plurality of scanners. The fourth scanner may comprise a fourth scanner position sensitive detector arranged to detect electromagnetic radiation arising from interaction of the laser beams with the powder bed and view the powder bed via a movable optical component of the fourth scanner used to steer the fourth laser beam.

The scanner may comprise an optical component movable under the control of a first actuator to direct the laser beam across the powder bed in a first dimension and the or a further optical component movable under the control of a second actuator to direct the laser beam across the powder bed in the first dimension.

The second actuator may provide a faster dynamic response but a smaller range of movement of the laser beam in the first dimension than the first actuator. The first actuator may be a galvanometer. The second actuator may be a piezoelectric actuator.

The powder bed fusion apparatus may comprise another scanner for steering another laser beam and the movable optical component may be an optical component of the other scanner. The position sensitive detector may be an on-axis detector of the other scanner.

The powder bed fusion apparatus may comprise a controller for controlling the scanner(s), and the position sensitive detector, the controller arranged to carry out the method according to the first aspect of the invention.

According to a third aspect of the invention there is provided a data carrier having instructions stored therein, which, when executed by a controller of a powder bed fusion apparatus according to the second aspect of the invention, cause the controller to carry out the method of the first aspect of the invention.

The data carrier of the above aspects of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

According to a fourth aspect of the invention there is provided a scanner for scanning a laser beam across a powder bed, the scanner comprising optical components including steering optics for steering a laser beam across a working plane, movable focussing optics for dynamically adjusting a focus of the laser beam synchronously with changes in positioning of the steering optics, and a turning mirror on the optical path between the movable focussing optics and the steering optics, the turning mirror configured for reflecting a laser beam, which has passed through the movable focussing optics, to the beam steering optics.

A plane of incidence of the laser beam on the turning mirror may be transverse, preferably perpendicular, to the working plane. The working plane is a plane at which the laser beam is intended to interact with material. For example, the scanner may be configured for mounting on a powder bed fusion apparatus and the working plane is a surface of a powder bed. The focussing optics may be arranged to maintain a focal position of the laser beam in a plane parallel to (such as above, below or at) the working plane with changes in position of the steering optics. In this way, an optical path of the laser beam is folded between the focussing optics and the steering optics reducing a footprint of the scanner in a plane parallel to the working surface. For example, in use on a powder bed fusion apparatus, the scanner may be mounted such that the focussing optics is located above the steering optics.

A plane of incidence of the laser beam on the turning mirror may be transverse, preferably perpendicular, to a mounting plane in which the scanner is configured to be mounted on apparatus, such as a powder bed fusion apparatus. For example the scanner may comprise mounting formation that define a mounting plane.

The scanner may comprise a housing including an optical opening through which the laser beam passes out of the housing to the working surface, the optical components contained in the housing arranged to direct the laser beam from a laser beam source and out of the optical opening. A plane of incidence of the laser beam on the turning mirror may be transverse to a plane of the optical opening. The term “optical opening” as used herein means an outlet for the laser beam is pass out of the housing and the electromagnetic radiation detected by the detector to pass into the housing. In one embodiment, the optical opening may be sealed, for example to dust and/or hermetically, by a window made of material transparent to the laser beam. The plane of the optical opening may be a plane defined by the window, such as a plane of an optical aperture of the window.

The scanner may comprise a connection for a laser beam delivery optic for introducing the laser beam into the scanner. The connection may be arranged such that laser beam delivery optic is located on a side of the scanner opposite the optical opening, such as the window made of material transparent to the laser beam.

In this way, a footprint of the scanner parallel to a plane of the window of the powder bed and/or a height of the scanner between the steering optics and the opening through which the laser beam exits the scanner can be reduced. For example, the movable focussing optics can be located such that an optical path of the laser beam through the movable focussing optics is not parallel to the working plane, such as a plane of a surface of the powder bed. For example, if the surface of the powder bed is horizontal, the movable focussing optics may be located such that the optical path of the laser beam through the movable focussing optics is transverse, such as perpendicular, to the horizontal. In this way, the movable focussing optics can be located above the steering optics to reduce a footprint of the scanner in the horizontal plane.

According to a fifth aspect of the invention there is provided a scanner comprising first steering mirror for steering a laser beam across a powder bed in a first dimension and second steering mirror for steering the laser beam across the powder bed in the first dimension, the first steering mirror having a smaller optical aperture than the second steering mirror.

The term “optical aperture” as used herein means the maximum diameter of a light beam that can pass through, be reflected from or detected by the optical component. The scanner may further comprise a turning mirror in the optical path between the first steering optic and the second steering optic, the turning mirror configured to reflect the laser beam to the second beam steering mirror.

The turning mirror may be further configured to transmit electromagnetic radiation arising from interaction of the or another laser beam with the powder bed to a detector, such as a position sensitive detector. The scanner may comprise the detector or the detector may be part of a monitoring module connectable to the scanner.

The first steering mirror may have a faster dynamic response than the second steering mirror. The first steering mirror may rotate about a first range of angles smaller than a second range of angles about which the second steering mirror rotates. By using a smaller mirror for the first steering mirror compared to the second steering mirror, a mirror with lower angular inertia can be used, such that the steering mirror can have a faster dynamic response. A smaller mirror will have a smaller optical aperture.

The turning mirror (of any of the above aspects of the invention) may reflect the laser wavelength with a reflectivity of greater than 99% and preferably, greater than 99.5%. Even at these high levels of reflectively. sufficient electromagnetic radiation at the laser wavelength may be transmitted through the turning mirror to the position sensitive detector to enable detection of a laser spot of the or another laser beam at the laser wavelength.

The turning mirror may reflect non-laser wavelengths of the electromagnetic radiation detected by the detector with a reflectively of less than 80%. Such non-laser wavelengths may be at lower intensity and therefore, it may be advantageous for the turning mirror to be configured to reflect such wavelengths less efficiently such that more of the light passes to the detector.

The detector may be a position sensitive detector. The position sensitive detector may be an isotropic position sensitive detector. The use of the isotropic position sensitive detector may be advantageous as a position of a centroid of an image of a laser spot, melt pool or plasma plume can be determined even if the image is out of focus. The scanner may comprise the detector or the detector may be part of a monitoring module connectable to the scanner.

Furthermore, the isotropic position sensitive detector is out of the way of other optics that may be located before the focussing optics in the laser beam optical beam path, such as a piezo-actuated steering mirror, as disclosed in WO2016/156824, which is incorporated herein in its entirety by reference. A field of view of the isotropic position sensitive detector is typically larger than an optical aperture of a piezo-actuated steering mirror. Accordingly, it is desirable to locate the isotropic position sensitive detector after the piezo-actuated steering mirror (“after” from the point of view of travel of the laser beam along the optical path) such that the field of view of the isotropic position sensitive detector is not limited by the optical aperture size of the piezo-actuated steering mirror. Furthermore, it is desirable to locate the piezo-actuated steering mirror close to the beam delivery optic (BDO) of the laser beam. Reducing a number of turning mirrors in the laser beam path reduces losses in the system, reducing undesirable heating of a scanner.

The scanner of the fourth or fifth aspect of the invention may be incorporated into a powder bed fusion apparatus according to the second aspect of the invention.

### DESCRIPTION OF DRAWINGS

FIG. 1 is a schematic diagram of a powder bed fusion apparatus according to an embodiment of the invention viewed from a side;

FIG. 2 is a schematic diagram of the powder bed fusion apparatus shown in FIG. 1 viewed from above;

FIG. 3 is a perspective view of galvanometer system of an optical scanner of the powder bed fusion apparatus shown in FIGS. 1 and 2;

FIG. 4 is a schematic diagram of a position sensitive detector of a third scanner capturing images of laser spots generated by first and second scanners;

FIG. 5 is a plan view of the position sensitive detector's field of view capturing images of laser spots generated by three scanners;

FIG. 6 is a plan view of a position sensitive detector's field of view of another scanner capturing images of laser spots generated by three scanners;

FIG. 7 illustrates the combinations of laser beam positions recorded by the position sensitive detector of each scanner;

FIG. 8 shows a pattern scanned by a laser beam during the recording of positions by a position sensitive detector;

FIGS. 9a and 9b are side and plan views, respectively, illustrating a laser beam melting powder, wherein the laser beam is moving opposed to a gas flow direction, and a resulting melt pool and plasma plume;

FIGS. 10 and 10b are side and plan views, respectively, illustrating a laser beam melting powder, wherein the laser beam is moving in the same direction as the gas flow, and a resulting melt pool and plasma plume;

FIG. 11 illustrates diffuse reflection of the laser beam from the powder bed and specular reflection of the laser beam from consolidated material;

FIG. 12 is a schematic illustration of an optical scanner and position sensitive detector according to another embodiment of the invention; and

FIG. 13 illustrates the spot size and shape on the position sensitive detector when the laser beam is directed to (a) a centre of the powder bed, (b) halfway between the centre and an edge of the powder bed, and (c) the edge of the powder bed.

### DESCRIPTION OF EMBODIMENTS

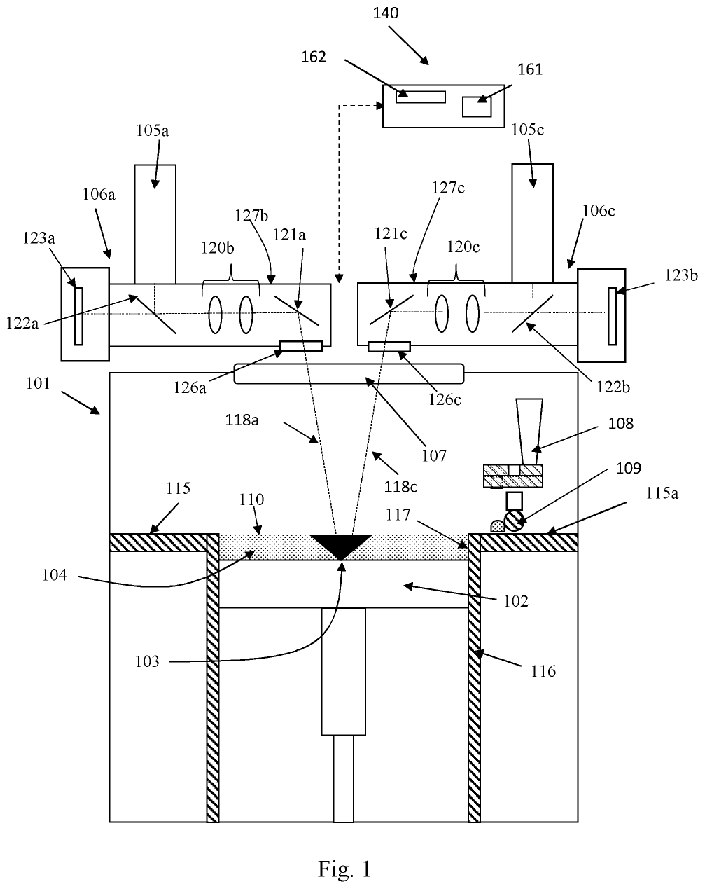

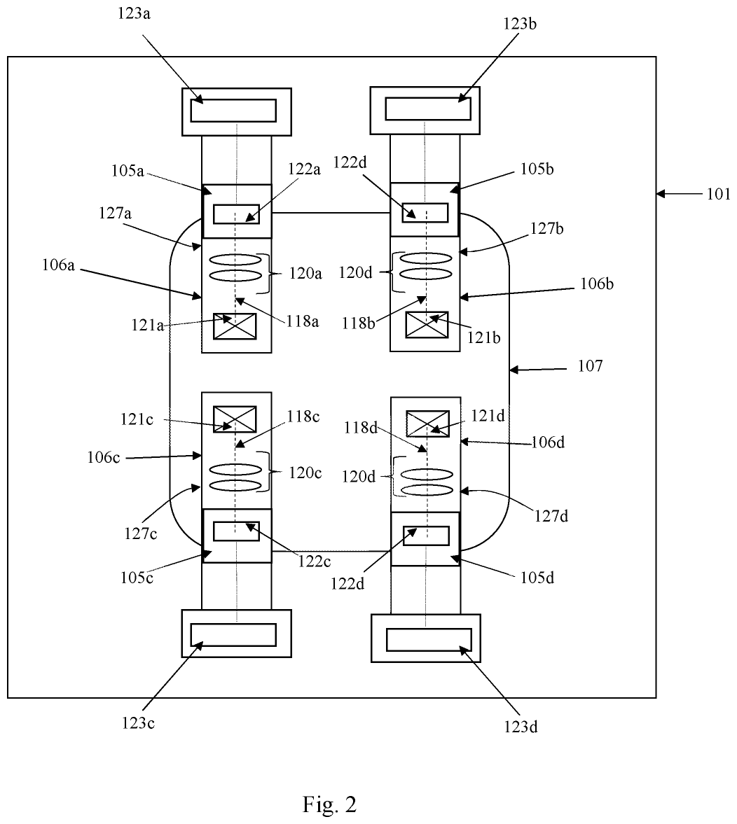

Referring to FIGS. 1 and 2, an additive manufacturing powder bed fusion apparatus according to an embodiment of the invention comprises a build chamber 101 having therein a processing plate 115 having an aperture therein and a build sleeve 116 extending down from the aperture. A build platform 102 is lowerable in the build sleeve 116 such that build sleeve 116 and build platform 102 together define a build volume 117. The build platform 102 supports a powder bed 104 and workpiece 103 as the workpiece is built by selective laser melting of the powder. The platform 102 is lowered within the build sleeve 116 under the control of a drive mechanism (not shown) as successive layers of the workpiece 103 are formed.

Layers of powder 104 are formed as the workpiece 103 is built by dispensing apparatus 108 and a recoater, in this embodiment a wiper 109. For example, the dispensing apparatus 108 may be apparatus as described in WO2010/007396. The dispensing apparatus 108 dispenses powder onto an upper surface 115a defined by partition 115 and is spread across the powder bed by wiper 109. A position of a lower edge of the wiper 109 defines a working plane 110 at which powder is consolidated.

A gas nozzle and gas exhaust (not shown) are provided for generating a gas knife across the powder bed 104. In this embodiment, the gas nozzle and gas exhaust are provided to generate a gas flow in or out of the page in FIG. 1.

A plurality of laser modules 105a, 105b, 105c and 105d generate laser beams 118a, 118b, 118c, 118d for melting the powder 104, the laser beams 118a, 118b, 118c, 118d directed as required by a corresponding laser beam scanner 106a, 106b, 106c, 106d. The laser beams 118a, 118b, 118c, 118d enter through a common laser window 107.

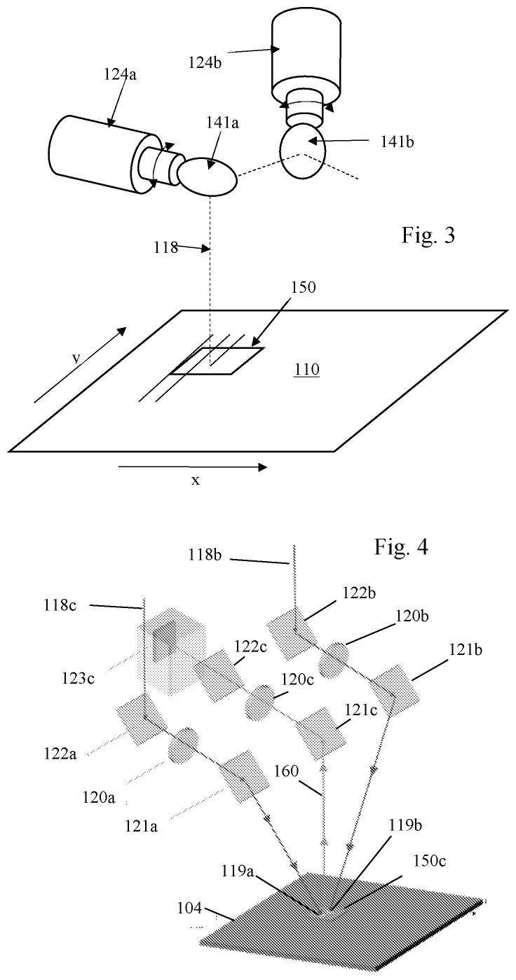

Each laser beam scanner 106a, 106b, 106c, 106d comprises movable optical components optics 121, such a two mirrors 141a, 141b mounted on galvanometers 124a, 124b (as shown in FIG. 3), for steering the laser beam 118 in perpendicular directions X and Y across the working plane and focussing optics 120, such as two movable lenses for changing the focus of the laser beam 118. The scanner is controlled such that the focal position of the laser beam 118 remains in the same plane as the laser beam 118 is moved across the working plane. Rather than maintaining the focal position of the laser beam in a plane using dynamic focusing elements, an f-theta lens may be used.

Each scanner 106a, 106b, 106c, 106d comprises a beam splitter/turning mirror 122 which reflects the majority of the laser beam 118 emitted from the laser 105 towards the powder bed 104 and transmits a small percentage of light of the laser wavelength coming from the working plane of the powder bed 104 to a position sensitive detector (PSD) 123. Typically, the beam splitter 122 will have a coating that reflects at least 99% of light at the laser wavelength. In this embodiment, the laser wavelength is 1080 nm. The radiation that passes through the beam splitter 122 is detected by the position sensitive detector 123, in this embodiment in the form of an isotropic position sensitive detector. The optical system may comprise further filters for filtering out wavelengths that are not of interest before the radiation is incident on the detector 123, such as wavelengths other than that of the laser beam. In this way, a field of view (FOV) 150 of the position sensitive detector 123 can be moved to different positions on the powder bed 104 by the mirrors 141a, 141b. An alignment between the FOV 150 and the laser beam 118 directed by that scanner 106 may be uncertain and/or subject to change, for example due to thermal changes during the build. Accordingly, the FOV 150 may not be or may not remain centred about the laser beam 118. The FOV 150 may have a width at the working plane 110 (e.g. in both X and Y directions) greater than tens of laser spot diameters but less than, such as tens or preferably hundreds of times less than, the width of the working surface 110 of the powder bed 104. The 1/e² laser spot diameter is typically 60-100 μm so the width of the FOV 150 may be greater than 600 μm. A width of a working surface of the powder bed is typically 100 mm to 500 mm so the width of the FOV 150 may be less than 50 mm and preferably less than 20 mm. In this embodiment, the FOV 150 is about 9 mm square. A smaller FOV 150 increases resolution whereas a larger FOV 150 allows metrology measurements to be carried out when scanning locations of the optical modules 106a, 106b, 106c, 106d are further apart.

The optical components are contained within a housing 127 and the laser beam 118 is directed out of the housing 127 via a window 126 transparent to the laser wavelength.

A controller 140, comprising processor 161 and memory 162, is in communication with modules of the additive manufacturing apparatus, namely the laser modules 105a, 105b, 105c, 105d, scanners 106a, 106b, 106c, 106d, build platform 102, dispensing apparatus 108, wiper 109 and PSDs 123a, 123b, 123c, 123d. The controller 140 controls the modules based upon software stored in memory 162 as described below. The controller 140 may provide deterministic control of the modules, for example, as is described in WO017/085469, which is incorporated herein in its entirety by reference.

Before the build commences, a calibration of the optical scanners 106a, 106b, 106c, 106d is carried out. This calibration should include scanner to scanner alignment such that each scanner 106a, 106b, 106c, 106d steers the corresponding laser beam 118a, 118b, 118c, 118d to the same points when demanded to do so. In this way, steps, witness lines and/or porosity is avoided at locations in the object where one scanner 106a, 106b, 106c, 106d hands over to another. For example, the calibration may be carried out in the manner described in WO2022/008885, which is incorporated herein in its entirety by reference.

During a build or multiple builds, the relative positioning of the laser beams 118a, 118b, 118c, 118d by the scanners 106a, 106b, 106c, 106d may drift, for example due to thermal changes within the machine, such that each scanner 106a, 106b, 106c, 106d steers the corresponding laser beam 118a, 118b, 118c, 118d to different points when demanded to steer the laser beams to the same point. This can result in problems with the build. To overcome this problem, the powder bed fusion apparatus is controlled to align the positioning of the laser beams 118a, 118b, 118c, 118d by the scanners 106a, 106b, 106c, 106d during the build. This method may be carried out between the completion of one layer and before commencing consolidation of the successive layer, during consolidation of a layer, such as during hand-over from one scanner to another, such as along a scan path or when three scanners come into close proximity to each other during the build, for example at abutting stripes or stripe sections, such that the irradiation point on the powder bed generated by one, and preferably two other, laser beam(s) is within the field of view (FOV) 150 of the PSD 123 of anther scanner 106. Furthermore, the method may be completed (started and finished) during a single layer or across multiple layers.

Referring to FIG. 4, the method comprises positioning a first and a second one of the scanners 106a, 106b, 106c, 106d such that a first point 119a irradiated by a first laser beam of the first scanner and second point 119b irradiated by a second laser beam of the second scanner is within the FOV 150 of the position sensitive detector 123 of a third one of the scanners 106a, 106b, 106c, 106d. The laser beams 118 are directed onto powder, which acts as a diffuse reflector of the laser light enabling the position sensitive detector 123 of the third scanner, which is not on the optical axis of the laser beam 118 directed by the first or second scanner 106, to detect the laser light 160 reflected away from the optical axis of the laser beams 118. Positions of images on the position sensitive detector 123 generated by the irradiation points (reflected laser light) of the first and second laser beams are recorded. During recording of these positions, the laser beam directed by the third scanner (the scanner comprising the PSD 123 that records the positions) is off. The recording of the positions may be done sequentially rather than simultaneously. For example. The FOV 150 may be maintained in a position (stationary) whilst the first laser beam is fired and the second laser beam is off, and then the second laser beam fired when the first laser beam is off.

The positions of the images on the position detector (or a position vector between the positions) are (is) transformed into corresponding positions (a position vector) in the FOV 150. For example, the transformation may be a scaling to take into account a magnification of focussing optics 120 between the position sensitive detector 123 and the surface 110 of the powder bed 104.

The method comprises determining an adjustment to be made to positioning of the plurality of scanners 106a, 106b, 106c, 106d based on the first and second positions in the FOV 150 compared to an expected positioning. In this embodiment, the adjustment is based on a position vector, in the reference frame of the FOV 150, between the first and second positions. The expected positioning is determined from the demand positions sent to the scanners 106a, 106b, 106c, 106d at the time the position is recorded (both the timing of which is known because of the deterministic control). As the positions are recorded at different times, the expected positioning may be that the first and second positions are the same. An offset between the measured positions and the expected positioning corresponds to an adjustment to be made to the positioning of the laser beams by the scanners 106a, 106b, 106c, 106d. An adjustment to each scanner is made in a direction of the offset but half the magnitude. In this way, adjustment of the scanners 106a, 106b, 106c, 106d progressing further and further away from an initial alignment setting until the offset is at an extremum of its adjustment range is avoided.

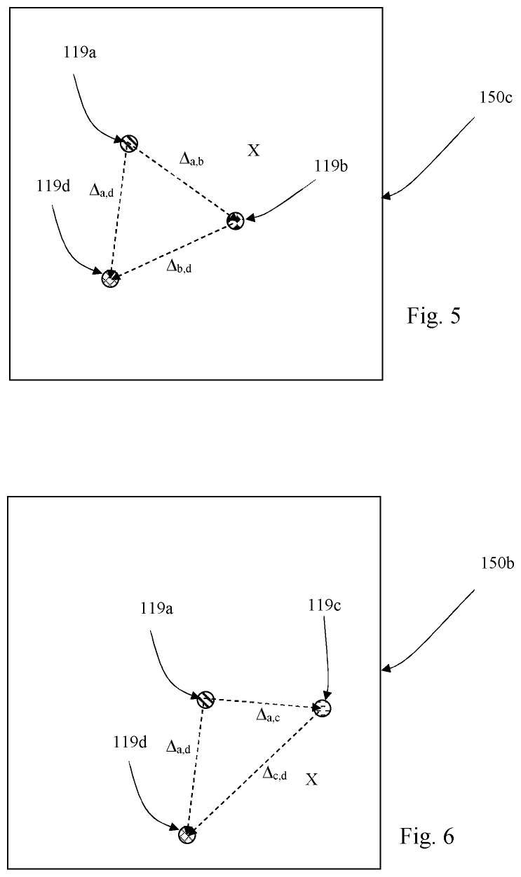

Referring to FIGS. 5 and 6, the method may comprise recording positions of three irradiation points with each PSD 123. FIG. 5 shows the PSD 150c of scanner 106c recording the positions of irradiation point 119a, 119b and 119d generated by scanners 106a, 106b, and 106d, respectively. As described above, the recording of the positions may be done sequentially rather than simultaneously.

For each scanner 106, a centre of the field of view 150 of the PSD 123 may be offset from a position in the FOV 150 the laser beam 118 would be directed to by the scanner 106. This is illustrated by the X in FIGS. 5 and 6, which is offset from a centre of the FOV 150c, 150d and located at a different location in each FOV 150c, 150d. FIG. 5 illustrates the recording of positions of irradiation points 119a, 119b and 119d produced by laser beams 118a, 118b, 118d steered by scanners 106a, 106b, 106d in the FOV 150c of PSD 123c. A position vector Δ_{a,b}, Δ_{a,d}, Δ_{b,d} is determined for each pair of positions in the FOV 150c. FIG. 6 illustrates the recording of positions of irradiation points 119a, 119c and 119d produced by laser beams 118a, 118c, 118d steered by scanners 106a, 106c, 106d in the FOV 150b of PSD 123b. A position vector Δ_{a,b}, Δ_{a,d}, Δ_{c,d} is determined for each pair of positions in the FOV 150b. This is repeated for the PSDs 123a and 123d of scanners 106a and 106d. A position of each irradiation point 119a, 119b, 119c, 119d may be recorded by multiple ones of the PSDs 123a, 123b, 123c, 123d in the corresponding FOV 150a, 150b, 150c, 150d, i.e. multiple ones, such as three, of the PSDs 123a, 123b, 123c, 123d are directed to the required location and records data when a laser beam irradiates the powder to generate the irradiation point 119a, 119b, 119c and 119d.

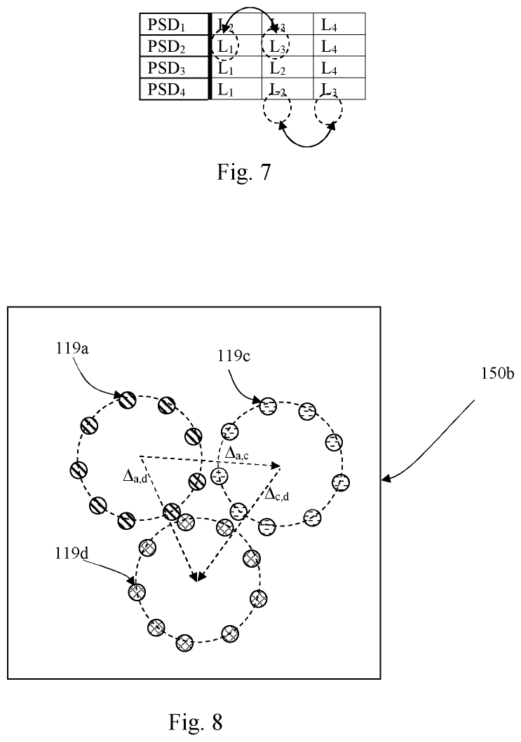

FIG. 7 illustrates how this method results in a PSD (PSD₁) of a first one of the scanners recording positions of irradiation points generated by laser beams L₂, L₃, L₄ directed by second, third and fourth ones of the scanners. A PSD (PSD₂) of a second one of the scanners records positions of irradiation points generated by laser beams L₁, L₃, L₄ directed by first, third and fourth ones of the scanners. A PSD (PSD₃) of a third one of the scanners records positions of irradiation points generated by laser beams L₁, L₂, L₄ directed by first, second and fourth ones of the scanners. A PSD (PSD₄) of a fourth one of the scanners records positions of irradiation points generated by laser beams L₁, L₂, L₃ directed by first, second and third ones of the scanners. This round-robin approach results in the relative position of two irradiation points being recorded twice by different PSDs. An example of this is illustrated by the dotted circles and arrows, wherein PSD₁ and PSD₄ record the relative positioning between irradiation points produced by lasers L₂ and L₃. By recording the positioning of corresponding laser beams by a pair of scanners with two (or more) different PSDs, inaccuracies in one PSD can be mitigated, for example by averaging or by disregarding measurements of one PSD if the position vectors determined by this PSD for all pairs (in this embodiment three pairs) is substantially different from the same measurement with the other PSDs.

The adjustment is then determined from the position vectors determined by the PSDs in the same manner as described above.

In the above embodiments, recording of the position of the irradiation point in the FOV may be carried out during consolidation of powder.

In a further embodiment schematically illustrated in FIG. 8, the PSD 123 of each scanner 106a, 106b, 106c, 106d records positions for a plurality of irradiation points 119a, 119c, 119d generated by the other scanners 106a, 106b, 106c, 106d. The plurality of irradiation points is nominally arranged in accordance with a known shape. In this embodiment, each laser beam is scanned in a circle and positions of the irradiation points are recorded by the PSD 123 as the laser beam moves around the circumference of the circle. For the positions recorded for a particular scanner 106a, 106b, 106c, 106d, the known shape, in this embodiment a circle, is fitted to the recorded positions and a centroid is determined. Position vectors Δ_{a,c}, Δ_{a,d}, Δ_{c,d} are determined between the centroids calculated from each set of irradiation points 119a, 119c, 119d.

As with the previous embodiment, a round robin approach may be used such that the relative position of two centroids can be independently calculated twice from the positions recorded by different PSDs. An adjustment to the scanners is determined from the calculated position vectors as described above. In this embodiment, the expected positioning is a centroid of a shape from which the demand positions for exposures around the outline of the shape are determined.

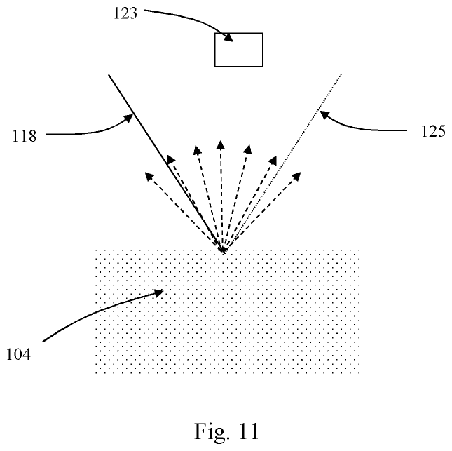

The centroids of the patterns, in this embodiment the circles, may be nominally coincident. Any difference in a positioning of the centroids may be due to misalignment of the scanners 106a, 106b, 106c, 106d. To use detection of light of the laser wavelength to determine the position of coincident centroids, the points are irradiated with the laser beams at a fluence below that which consolidates (melts or sinters) the powder. This may be required as the consolidated powder results in specular reflection (shown by dotted line 125 in FIG. 11) of the laser beam 118 whereas the powder results in diffuse reflection (shown by the dotted arrowed lines in FIG. 11) of the laser beam 118. The position sensitive detector 123 of the scanner detecting the position may not be correctly positioned to detect laser light reflected in a specular manner from consolidated material (i.e. along the angle of reflection), whereas if the laser light has been reflected in a diffuse manner the position of the position sensitive detector 123 is less critical. This is illustrated in FIG. 11, wherein the position sensitive detector 123 is not located on the path along which specular reflected laser light 125 travels, whereas it is able to detect diffusely reflected laser light in a multitude of positions.

In the above-described embodiments, the method is repeated at multiple locations across the working plane 110. A map of adjustments across the working plane may be determined from the adjustments determined for each of the multiple locations. The multiple locations in the working plane may be based on positions measured for points irradiated on the same powder layer or for points irradiated on different powder layers. Significant drift of the scanners 106a, 106b, 106c, 106d that requires correction is likely to occur over tens or hundreds of layers. Accordingly, generating a map of adjustments across different layers may be acceptable. Furthermore, changes in scanning patterns between layers, such a rotation of scan patterns, may alter locations in the working plane where the scanners hand-over providing opportunities to measure alignment of the scanners for different locations in the working plane 110. In a further embodiment, a bespoke calibration pattern may be used for alignment, such as the circles as described above. To avoid unwanted effects on the part, the calibration pattern may be scanned with a laser fluence below that which consolidates (melts or sinters) the powder.

In the above-described embodiments, the FOV 150 of the position sensitive detector may be stationary on a surface of the powder bed when recording the positions. In another embodiment, the FOV 150 may be moved between recording positions of the irradiated points 119a, 119b, 119c, 119d. In such an embodiment, the FOV 150 may be nominally positioned in the same relationship relative to the demand position(s) of the irradiated points 119a, 119b, 119c, 119d. Accordingly, any offset of the FOV 150 from its nominal position will not contribute to a measurement of relative positions in the FOV 150 between the irradiated points 119a, 119b, 119c, 119d or centroid calculated therefrom. As long as changes in position between recording positions for the different points 119a, 119b, 119c, 119d are small, any difference in positioning the FOV from its nominal position will be the same for all points 119a, 119b, 119c, 119d.

In the above-described embodiments, the controller 140 is arranged, such as programmed with suitable instructions, to control the optical modules 106a, 106b, 106c, 106d to synchronise the scans carried out by the optical modules 106a, 106b, 106c, 106d such that the laser beams 118a, 118b, 118c, 118c fall within the FOV(s) 150 (requiring temporal and spatial synchronisation). This can be achieved by setting a time of execution within the commands sent to the optical modules 106a, 106b, 106c, 106d to ensure appropriate timings of the scans. Improvements in synchronisation may allow a smaller FOV 150 to be used and therefore, better metrology resolution.

The methods may be carried out when melting material with the laser beams 118a, 118b, 118c, 118d or the laser power, scan speed, spot size or other scanning parameters may be selected such that the laser fluence is below that required to consolidate during the irradiation of points 119a, 119b, 119c, 119d. In all cases, the measurement is coincident with the working plane.

Alternatively, the position sensitive detectors 123 are arranged to detect electromagnetic radiation emitted by a plasma plume generated during irradiation of the powder bed by the laser beams 118a, 118b, 118c, 118d to melt powder. For example, the beam splitter 122 may be arranged to transmit wavelengths emitted from the plasma plume and block the laser wavelength.

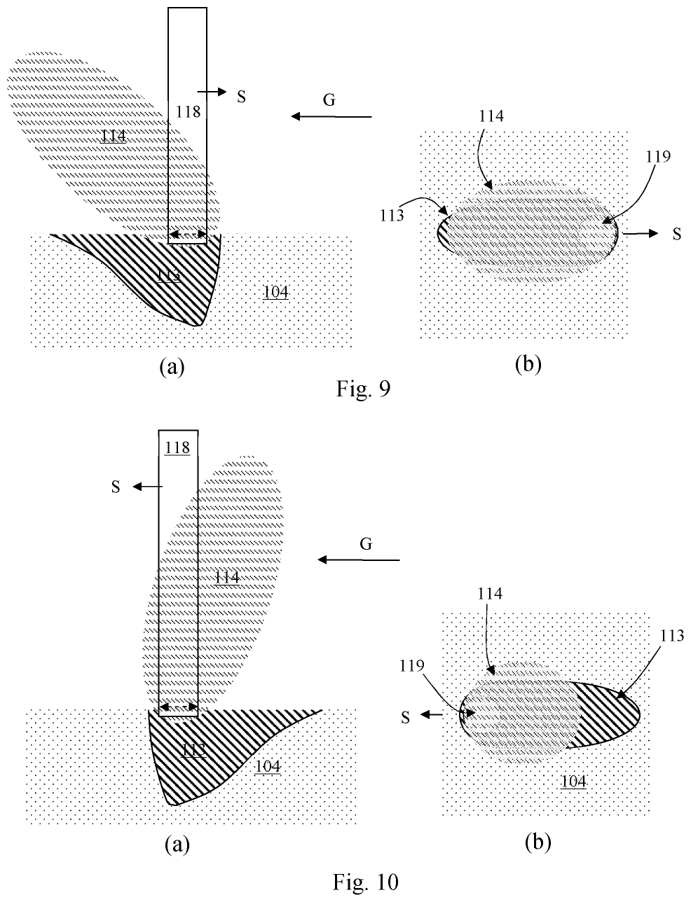

FIGS. 9 and 10 illustrate the different sources of electromagnetic radiation during irradiation of the powder bed to melt the powder. The laser beam 118 generates a laser spot 119 on the powder bed from which laser light is reflected. The laser light absorbed by the powder bed causes a melt pool 113 to form (if the energy flux is high enough) which also emits light. Formation of the melt pool also causes a plasma plume 114 to be formed from vaporised material above the melt pool 113. The melt pool 113 and plasma plume 114 emit light over a much broader range of wavelengths than the laser wavelength but at a lower intensity than the reflected laser light. Accordingly, in order to detect the light emitted from melt pool 113 or the plasma plume 114, the laser wavelengths must be filtered out otherwise the reflected laser light will saturate the PSD 123. When scanning the laser beam 118 across the bed, an oblong shaped melt pool is formed in the working plane extending a distance behind the laser beam in the scanning direction, S. The plasma plume 114 forms above the melt pool at least partially obscuring the melt pool from an on-axis sensor 123 within a scanner 106, the location of the plasma plume affected by a gas flow direction, G. in the build chamber 101. Typically, a gas knife is generated across the working plane to carry away condensate and other particle emissions from the locations where the powder bed is irradiated. When the laser beam is scanned in a direction, S, into the gas flow G, a low angled plasma plume is generated behind the laser beam 118, whereas, when the laser beam is scanned in a direction, S, with the gas flow G, a more upright plasma plume is generated behind the laser beam 118. Accordingly, a centroid of the plasma plume relative to a laser spot 119 changes depending on a scanning direction, and this can lead to inaccuracies in determining alignment of the scanners if the plasma plume is used as a proxy to determine a location of the laser spot. Using the melt pool 113 as a proxy for laser spot location can also be problematic because the centroid of the melt pool may not coincide with a location of the laser spot and the shape of the melt pool can change with processing conditions. However, it may be possible to mitigate these inaccuracies by comparing the relative positions of two irradiation points or two centroids formed under the same or substantially the same conditions such that systematic errors that cause the same shift in the point or centroid will be removed. Using electromagnetic radiation emitted by a plasma plume for metrology may allow for irradiation of polished metal surfaces, such as a build substrate, by the laser beams to be used for determining the adjustment to the positioning of the scanners.

In one embodiment, the above-described method is carried out as the wiper 109 moves across the powder bed 104. For example, the points 119 irradiated on the powder bed 104 may be located on the newly laid powder behind the wiper 109. At the same time or at other times during movement of the wiper 109 across the powder bed 104, the powder may be consolidated at selected locations. An example of scanning powder whilst wiping is described in WO2015/140547, which is incorporated herein in its entirety by reference. This method may be modified to include carrying out metrology whilst wiping in addition to consolidating material whilst wiping.

In an alternative embodiment, the above-described method is carried out using a position sensitive detector, such as a camera, mounted on the build chamber 101 such that its field of the view is fixed relative to a working surface 110 of the powder bed 104. The position sensitive detector may be arranged to detect electromagnetic radiation of the laser wavelength and positions are detected when the powder bed is irradiated with laser beams of scanners 106a, 106b, 106c, 106d having a fluence below that required to melt or sinter the powder. The position sensitive detector may view the working surface 110 through a window, such as window 107, in the wall or roof of the build chamber 101, Furthermore, two position sensitive detectors may be provided, wherein the position of an irradiated point or centroid in the working plane 110 may be determined from outputs from both position sensitive detectors. Like the above-described embodiments, the position of the field of the view of the position sensitive detectors may change during the build because of thermal effects, for example because of expansion of the build chamber 101 to which the position sensitive detectors are mounted. However, as the alignment relies on the relative position of the points or centroids within the frame of reference of the FOV, it is not necessary to know an absolute position of the FOV.

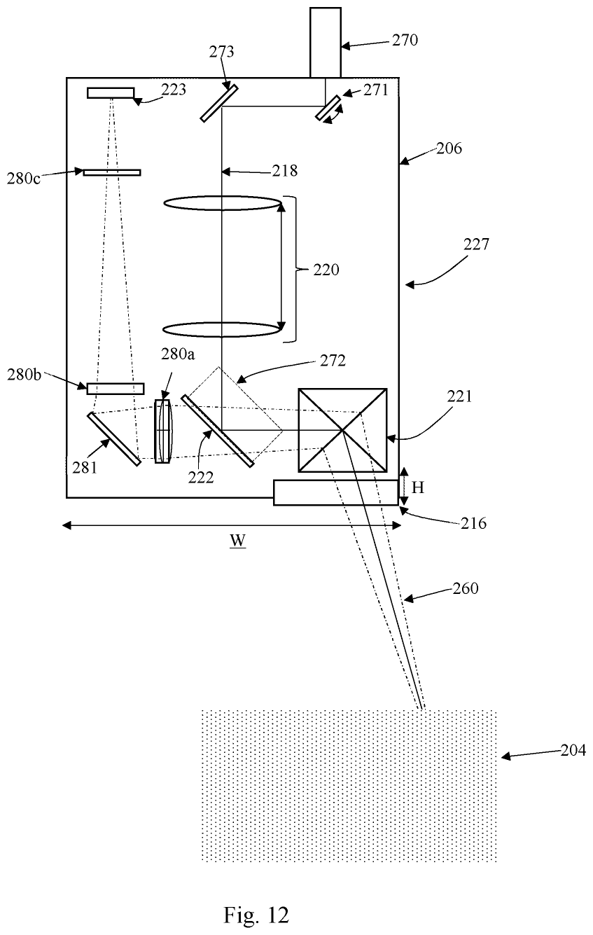

FIG. 12 shows a further scanner 206 according to the invention that may be used with the above-described powder bed fusion apparatus. The same reference numerals but in the series 200 have been used for features of this scanner that correspond to features of the scanner described with reference to FIGS. 1 to 3. Features of scanner 206 that are the same or similar to the previously described scanner will not be described again in detail and reference is made to the above description of these features. As with the above-described powder bed fusion apparatus, a plurality of scanners 206 may be used together in a powder bed fusion apparatus and calibrated, using the above-described method, such that the coordinate systems of the scanners are aligned.

Scanner 206 differs from the scanners 106a, 106b, 106c, 106d in that a turning mirror 222 is located between the focussing optics 228 and the steering optics 221, which may be like the steering optics described with reference to FIG. 3. Like the previously described embodiment, the movable focussing optics 228 comprises lenses, at least one or which is movable under the control of a drive, such as a voice coil, to change a focal length of the scanner 206. The turning mirror 222 reflects the laser beam 218 towards the steering optics 221. The turning mirror 222 is configured such that at least a proportion of the electromagnetic radiation 260, generated during interaction of the laser beam 218 or another laser beam (for example a laser beam directed by another scanner) with the powder bed 204 that passes back through the steering optics 221, is transmitted through the turning mirror 222 to a detector, in this embodiment an isotropic position sensitive detector 223.

The turning mirror 222 folds the optical path of the laser beam 218 such that, when the scanner 206 is mounted in a powder bed fusion apparatus, the focusing optics 220 is located above the steering optics 221. A plane of incidence 272 of the turning mirror 222 is transverse, in this embodiment perpendicular, to a working surface of the powder bed 204 and an optical aperture of the window 216. In this way, a footprint of the scanner 206 (indicated by arrow W) in a plane parallel to a surface of the powder bed 204 (a working surface) and to a plane of the window 216 can be made smaller than for a scanner 206 in which the optical axis of the laser beam is not folded between the focussing optics 220 and the steering optics 221. This may enable a plurality of scanners 206 to be stacked more closely together. Furthermore, a distance (e.g. height, H) between the opening, in this embodiment window 216, through which the laser beam exits the housing 227 and the steering optics 221 can be reduced because this height is no longer constrained by the dimensions of the movable focussing optics 220. This may allow a reduction in a dimension, such as diameter, of the opening/window 216, allowing a further reduction in a footprint, W, of the scanner 206. Furthermore, the focussing optics 222 are configured for the laser wavelength. By splitting the back-reflected electromagnetic radiation 260 before the radiation passes through the focussing optics, undesirable effects of the focussing optics 222 on the electromagnetic radiation is avoided. For example, for non-laser wavelengths, an image of electromagnetic radiation detected after passing through the focussing optics 222 may be defocussed, aberrated and/or displaced from the optical axis.

Electromagnetic radiation 260 that passes through beam splitter 222 is directed onto position sensitive detector 223. In this embodiment, a further turning mirror 281 is provided to direct the electromagnetic radiation 260 to the position sensitive detector 223 located above the steering optics 221. A plane of incidence of the further turning mirror 281 is transverse, in this embodiment perpendicular, to a working surface of the powder bed 204 and an optical aperture of the window 216. In this way, an optical path of the electromagnetic radiation 260 to the position sensitive detector 223 is folded to reduce a footprint W of the optical scanner 206. This results in two parallel optical paths, one for the electromagnetic radiation 260 and another for the laser beam 218, transverse, in this embodiment perpendicular, to a working surface of the powder bed 204 and an optical aperture of the window 216. Fixed focussing optics 280a, 280b and 280c are provided to focus the electromagnetic radiation 260 to a point in the vicinity of the position sensitive detector 223. The pair of lenses 280b, 280c are used to shorten the optical path of a longer focal length.

In this embodiment, a further steering mirror 271 is provided between the laser beam delivery optic (BDO) 270 and the focussing optics 220. The further steering mirror 271 may have a faster dynamic response than the steering optics 221 and may be able to move the laser beam in one or two dimensions. For example, the further steering mirror 271 may be a piezo-actuated steering mirror, as disclosed in WO2016/156824, which is incorporated herein in its entirety by reference. It is desirable to locate such a further steering mirror 271 close to the beam delivery optic 270. To enable the BDO 270 to be located at a top of the scanner 206 when the scanner 206 is mounted on the powder bed fusion apparatus, a turning mirror 273 is provided. In this embodiment, the turning mirror 273 is located after the further steering mirror 271 as it is beneficial to locate the further steering mirror 271 as close as possible to the BDO 270. Locating the further steering mirror 271 closer to the BDO 270 allows a smaller mirror to be used for the further steering mirror reducing inertia of the further steering mirror 271, which is beneficial for dynamic response. By locating the BDO 270 at a top of the scanner 206, multiple scanners 206, such as more than four scanners, can be stacked abutting together with their windows 216 in a common plane without the BDO 270 being in the way of such a stacking arrangement. However, in an alternative embodiment, the BDO 270 delivers the laser beam into a side of the scanner 206 (in the orientation when mounted on the powder bed fusion apparatus), and the turning mirror 273 is omitted.

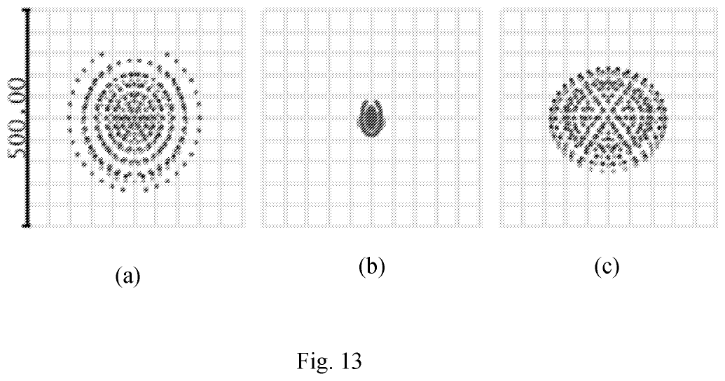

FIG. 13 shows the spot size on the position sensitive detector 223 at different locations on the working surface. As can be seen, the spot size on the position sensitive detector when the laser beam 218 is directed to the centre of the working surface (FIG. 13(a)) is different to the spot size on the position sensitive detector 223 when the laser beam 218 is directed to an edge of the working surface (FIG. 13(c)) and the spot size on the position sensitive detector when the laser beam 218 is directed midway between the centre of the working surface and the edge of the working surface (FIG. 13(b)). Furthermore, a shape of the image of the spot on the position sensitive detector 223 may change depending on the location of the laser beam on the working surface, in particular, as shape of the spot may diverge from circular, although it remains symmetrical about its centre. The position sensitive device 223 returns a position value corresponding to a centroid of the image projected onto the position sensitive device 223. Accordingly, for spot shapes that are approximately symmetrical in both X and Y directions, the position sensitive device 223 will return a position value substantially corresponding to a centre of the spot regardless of its position on the working surface and whether the spot is in focus on the position sensitive detector 223. In other words, not flattening the field for the back-reflected electromagnetic radiation that is directed to the position sensitive detector 223 does not hinder accurate position measurements of the centre of the laser spot.

It will be understood that modifications and alterations to the above-described embodiments may be made without departing from the scope of the invention as defined here.

For example, the method may be used to align the two steering elements within the same optical train. A scanner may comprise a first actuator, such as a galvanometer, for moving a first optical component, such as a mirror, for steering the laser beam in a first dimensions across the working plane 110 and a second actuator, having a faster dynamic response but a smaller range of movement than the first actuator, for moving a second optical component, such as a second mirror, for steering the laser beam in the first dimensions across the working plane 110. An example of such a scanner is described in WO2016/156824, which is incorporated herein in its entirety by reference. The method may be used to align steering of the laser beam using the first actuator with steering of the laser beam using the second actuator.

1-19. (canceled)

20. A scanner comprising a connection for a laser beam delivery optic for introducing the laser beam into the scanner, a first steering mirror for steering a laser beam across a powder bed in a first dimension, a second steering mirror for steering the laser beam across the powder bed in the first dimension, the first steering mirror having a smaller optical aperture than the second steering mirror, and a movable focussing optic for dynamically adjusting a focus of the laser beam synchronously with changes in positioning of the second steering mirror to maintain a focal position of the laser beam in a plane, wherein the first steering mirror is located along an optical path of the laser beam between the laser beam delivery optic and the movable focussing optic.

21. A scanner according to claim 20, wherein the first steering mirror has a faster dynamic response than the second steering mirror.

22. A scanner according to claim 20, wherein the first steering mirror rotates about a first range of angles smaller than a second range of angles about which the second steering mirror rotates.

23. A scanner according to claim 20, wherein the first steering mirror is a piezo-actuated steering mirror.

24. A scanner according to claim 20, wherein the second steering mirror is a galvanometer actuated steering mirror.

25. A scanner according to claim 20, wherein the first steering mirror is able to move the laser beam in two dimensions.

26. A scanner according to claim 20, further comprising a turning mirror in an optical path between the first steering mirror and the second steering mirror, the turning mirror configured to reflect the laser beam to the second steering mirror.

27. A scanner according to claim 26, wherein a plane of incidence of the laser beam on the turning mirror is transverse to a working plane.

28. A scanner according to claim 26, wherein a plane of incidence of the laser beam on the turning mirror is perpendicular to a working plane.

29. A scanner according to claim 26, wherein a plane of incidence of the laser beam on the turning mirror is transverse to a mounting plane in which the scanner is configured to be mounted on an apparatus.

30. A scanner according to claim 26, wherein a plane of incidence of the laser beam on the turning mirror is perpendicular to a mounting plane in which the scanner is configured to be mounted on an apparatus.

31. A scanner according to claim 26, comprising a housing including an optical opening through which the laser beam passes out of the housing to the working surface, optical components contained in the housing arranged to direct the laser beam from the laser beam delivery optic and out of the optical opening and a plane of incidence of the laser beam on the turning mirror is transverse to a plane of the optical opening.

32. A scanner according to claim 31, wherein the connection is arranged such that laser beam delivery optic is located on a side of the scanner opposite the optical opening.

33. A scanner according to claim 26, wherein the turning mirror is configured to transmit electromagnetic radiation arising from interaction of the or another laser beam with the powder bed to a detector.

34. A scanner according to claim 33, wherein the turning mirror reflects a laser wavelength with a reflectivity of greater than 99% and reflects non-laser wavelengths of the electromagnetic radiation detected by the detector with a reflectively of less than 80%.

35. A scanner according to claim 20, wherein the movable focussing optic comprises lenses, at least one or which is movable under the control of a drive to change a focal length of the scanner.

36. A scanner according to claim 35, wherein the drive is a voice coil.

37. A scanner according to claim 20, wherein the focussing optic is located such that an optical path of the laser beam through the focussing optic is not parallel to a working plane.

38. A powder bed fusion apparatus comprising a scanner according to claim 20 for directing a laser beam to different positions on a powder bed.

39. A powder bed fusion apparatus according to claim 38, comprising a plurality of the scanners stacked abutting together with windows of the scanners in a common plane.

40. A scanner for scanning a laser beam across a powder bed, the scanner comprising optical components including a steering mirror for steering a laser beam across a working plane, a movable focussing optic for dynamically adjusting a focus of the laser beam synchronously with changes in positioning of the steering mirror, and a turning mirror on the optical path between the movable focussing optic and the steering mirror, the turning mirror configured for reflecting a laser beam, which has passed through the movable focussing optics, to the beam steering mirror.

41. A scanner according to claim 40, comprising a housing including an optical opening through which the laser beam passes out of the housing to the working plane, the optical components contained in the housing and arranged to direct the laser beam from a laser beam delivery optic and out of the optical opening, and a plane of incidence of the laser beam on the turning mirror is transverse to a plane of the optical opening.

42. A scanner according to claim 41, comprising a connection for the laser beam delivery optic, the connection arranged such that laser beam delivery optic is located on a side of the scanner opposite the optical opening.
